(19) United States
(12) Patent Application Publication
(10) Pub. No.: US 2014/0025903 A1
(43) Pub. Date: Jan. 23, 2014

(54) MULTI-CORE PROCESSOR SYSTEM

(71) Applicant: FUJITSU LIMITED, Kawasaki-shi (JP)

(72) Inventors: Koichiro Yamashita, Hachioji (JP); Hiromasa Yamauchi, Kawasaki (JP); Takahisa Suzuki, Kawasaki (JP); Koji Kurihara, Kawasaki (JP)

(73) Assignee: FUJITSU LIMITED, Kawasaki-shi (JP)

(21) Appl. No.: 14/036,758

(22) Filed: Sep. 25, 2013

Related U.S. Application Data
(63) Continuation of application No. PCT/JP2011/057715, filed on Mar. 28, 2011.

(51) Int. Cl. G06F 12/14

(52) U.S. Cl. CPC G06F 12/1483
USPC 711/152

(57) ABSTRACT

A multi-core processor system includes CPUs; memory; and a memory protect controller that is disposed between the plurality of CPUs and the memory, and that accesses a first memory area consequent to an access request of the CPUs upon application execution and further accesses a second memory area established when the system is booted.

### CROSS REFERENCE TO RELATED APPLICATIONS

This application is a continuation application of International Application PCT/JP2011/057715, filed on Mar. 28, 2011 and designating the U.S., the entire contents of which are incorporated herein by reference.

### FIELD

The embodiment discussed herein is related to a multi-core processor system that protects software.

### BACKGROUND

Recently, an increasing number of devices employ a form of a multi-core processor system having plural cores in a single system. If application software (hereinafter, referred to as “app”) for a single-core processor system having a single core in a single system is run on the multi-core processor system, a lot of failures may occur. Even if software is newly developed for the multi-core processor system, verification of all the timings in a parallel running state where plural cores run simultaneously is difficult. Referring to FIGS. 10A and 11, description is given of what type of failures occur in the multi-core processor system.

FIGS. 10A, 10B, and 10C are explanatory views of an operation example where software for a single-core processor system is run on a multi-core processor system. FIG. 10A depicts a case where an app 1003 runs on the single-core processor system, while FIGS. 10B and 10C depict a case where the app 1003 runs on the multi-core processor system.

First, in FIG. 10A, a main thread 1004 of the app 1003 calls a function f(x) to utilize the result of f(x). The main thread 1004 activates a thread 1005 for an offload process executing f(x), and after the termination of the thread 1005, utilizes the result of f(x) to continue the process. The thread is a basic unit for managing the process performed by a CPU.

When the app 1003 runs on the single-core processor system, the main thread 1004 activates the thread 1005 at time t1. The thread 1005 terminates the process of f(x) at time t2 and then the main thread 1004 utilizes the result at time t3.

With reference to FIGS. 10B and 10C, description will be given of a case where the app 1003 runs on the multi-core processor system. If the app 1003 undergoes no operation verification in a multi-core processor system environment and proves to be unsafe, operations designated in FIG. 10B will occur, whereas if the app 1003 undergoes operation verification in the multi-core processor system environment and proves to be safe, operations designated FIG. 10C will occur. In the following description, a low-reliability app refers to an app that undergoes no operation verification in the multi-core processor system environment and proves to be unsafe and a high-reliability app refers to an app that undergoes operation verification in the multi-core processor system environment and proves to be safe. Existing as a method of verifying whether an object app is reliable in the multi-core processor system is a method of performing the verification at various timings.

If the app 1003 is the low-reliability app, the main thread 1004 running on a central processing unit (CPU) #1 activates the thread 1005 at time t1 on a CPU #2. Assume that the thread 1005 and another thread are allocated to the CPU #2. The thread 1005 terminates the process of f(x) at time t3.

Since the CPU #1 executes only the main thread 1004, the CPU #1 has more time during which the main thread 1004 is allocated than that on the single-core processor system. In consequence, the main thread 1004 utilizes the result of f(x) at time t2 that is earlier than time t3. Since the process of f(x) is not yet completed at time t2, the main thread 1004 may read in an unexpected value, which may bring about a failure.

If the app 1003 is the high-reliability app, the main thread 1004 has a synchronization process inserted prior to the utilization of the result of f(x). This allows the main thread 1004 to execute the synchronization process at time t2 prior to the utilization of the result of the function f(x). After the execution of the synchronization process, the thread 1004 waits till the completion of the process of the thread 1005 so that the process can safely be executed.

FIGS. 11A and 11B are explanatory views when a library called on the single-core processor system is called on the multi-core processor system. FIG. 11A depicts a case where a library A works on the single-core processor system and FIG. 11B depicts a case where the library A works on the multi-core processor system.

In FIG. 11A, an app X calls the library A. An app Y calls the library A and a library B. In this manner, the library A called on the single-core processor system need not be subjected to a specific management.

In FIG. 11B, the app X is executed by the CPU #1 and the app Y is executed by the CPU #2. If the library A has a shared resource, the library A takes measures to, for example, subject a context 1103 of the library A to exclusive control. As specific measures, the library A on the CPU #1 performs exclusive control with the library A on the CPU #2, through an interface 1104#1, using inter-processor communications (IPCs) 1105#1 and 1105#2. A library taking such measures is a high-reliability library and a library not taking such measures is a low-reliability library.

As a technique employed when executing such a high-reliability app and low-reliability app, for example, the system is domain-divided into a safe domain that is a high-reliability app group ensuring safe operations and an unsafe domain that is a low-reliability app group not ensuring the safe operations. Disclosed is a technique in which the safe domain accesses safe data that is inaccessible from the unsafe domain in a memory (see, for example, Published Japanese Translation of PCT Application, Publication No.2006-506754 and Japanese Laid-Open Patent Publication No. 2004-171563).

Disclosed as a data protection technique, for example, as a flash memory example is a technique of finding an unused preliminary block for use as an error block for a protection area. Disclosed as another data protection technique is, for example, a technique of disposing an area for duplicating a memory to avoid the destruction of important programs or data (see, for example, Japanese Laid-Open Patent Publication Nos. 2004-310770 and H5-108493).

In the case of executing the high-reliability app and the low-reliability app by applying the above conventional techniques, the multi-core processor system operates the high-reliability app and the low-reliability app in a divided manner. Accordingly, it is difficult for the multi-core processor system to which the conventional techniques are applied to operate the high-reliability app and the low-reliability app in a mixed manner.

### SUMMARY

According to an aspect of an embodiment, a multi-core processor system includes plural CPUs; memory; and a memory protect controller that is disposed between the plurality of CPUs and the memory, and that accesses a first memory area consequent to an access request of the CPUs upon application execution and further accesses a second memory area established when the system is booted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are explanatory views of an operation example when failure occurs and an operation example of a restoration process of a multi-core processor system 100 according to an embodiment;

FIG. 2 is a block diagram of a hardware example of the multi-core processor system 100;

FIG. 3 is a block diagram of an example of a functional configuration of the multi-core processor system 100;

FIG. 4 is an explanatory view of an example of an internal functional configuration of a memory protect controller 106;

FIG. 5 is an explanatory view of a registration example of the memory protect controller 106;

FIG. 6 is a flowchart of an example of a process procedure at the time of activation of the multi-core processor system 100;

FIG. 7 is a flowchart (part 1) of an example of a process procedure at the time of app switching in the multi-core processor system 100;

FIG. 8 is a flowchart (part 2) of an example of a process procedure at the time of app switching in the multi-core processor system 100;

FIG. 9 is a flowchart of an example of a process procedure at the time of an error of the multi-core processor system 100;

FIGS. 10A, 10B, and 10C are explanatory views of an operation example where software for a single-core processor system is run on a multi-core processor system; and

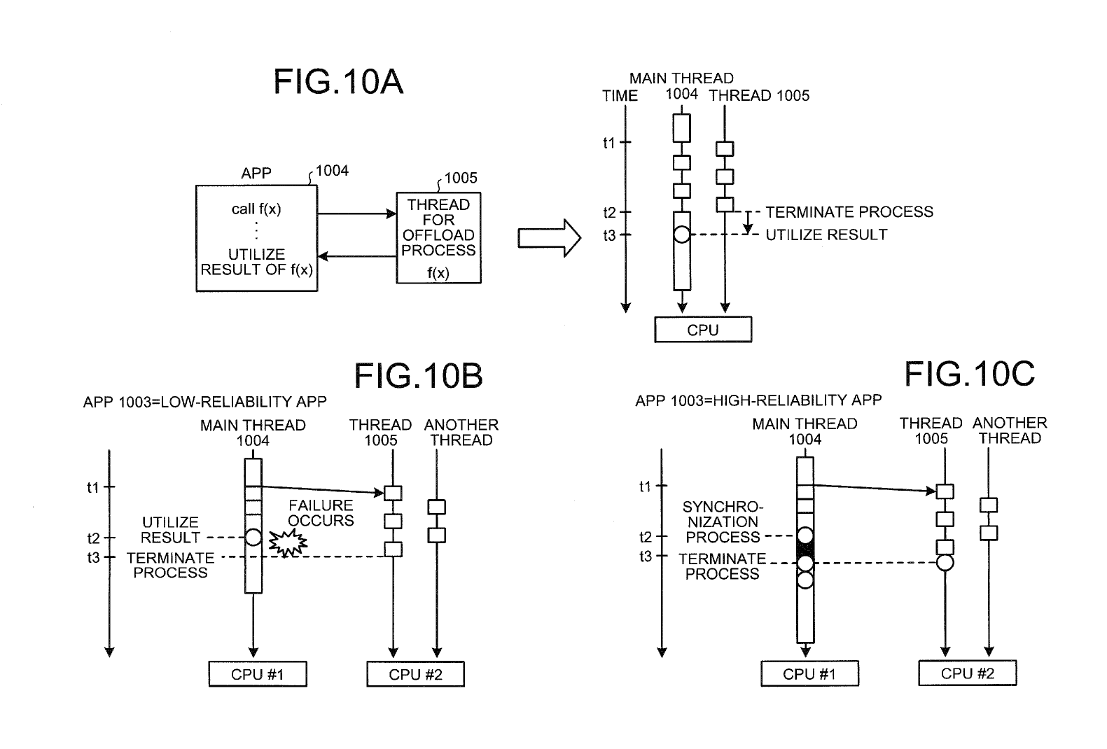

FIGS. 11A and 11B are explanatory views when a library called on the single-core processor system is called on the multi-core processor system.

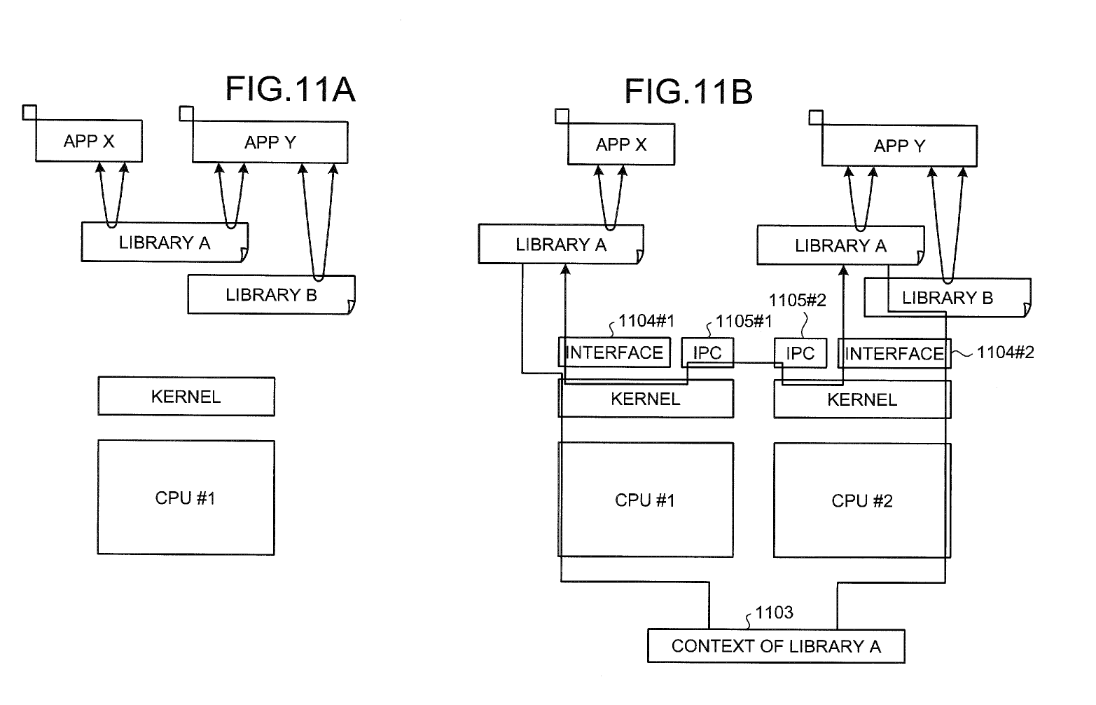

### DESCRIPTION OF EMBODIMENTS

An embodiment of a multi-core processor system will be described in detail with reference to the accompanying drawings.

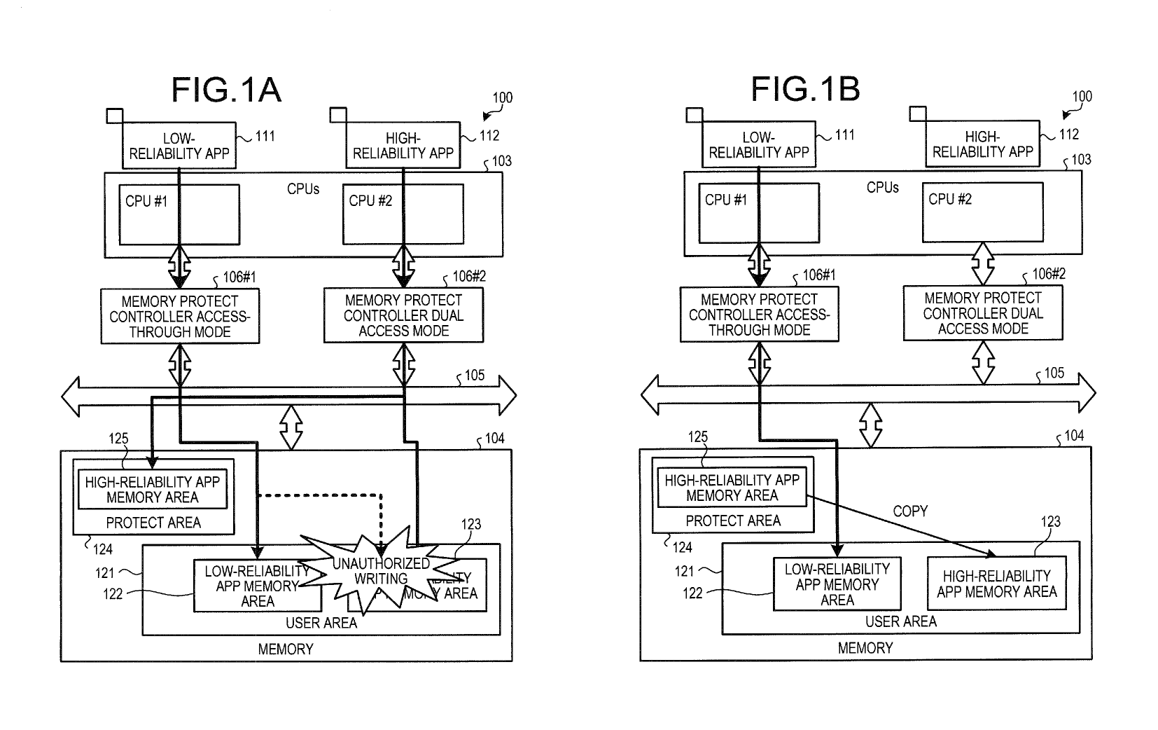

FIGS. 1A and 1B are explanatory views of an operation example when failure occurs and an operation example of a restoration process of a multi-core processor system 100 according to an embodiment. FIG. 1A depicts the operation example when failure of the multi-core processor system 100 occurs and FIG. 1B depicts the operation example of the restoration process of the multi-core processor system 100.

The multi-core processor system 100 of FIGS. 1A and 1B includes CPUs 103 acting as multiple cores, and memory 104. The multi-core processor system 100 is assumed to be a portable terminal such as a mobile phone. The CPUs 103 include a CPU #1 and a CPU #2. A reference numeral associated with a suffix “#n” hereinafter means that the reference numeral corresponds to an n-th CPU. The CPUs 103 and the memory 104 are connected through a bus 105. The CPU #1 and the CPU #2 can communicate with a memory protect controller 106#1 and a memory protect controller 106#2, respectively.

The memory protect controller 106 is an apparatus performing operation corresponding to a specified mode among two modes, i.e., a dual access mode and an access-through mode. If an instruction for the dual access mode is given, the memory protect controller 106 has a function of accessing an original requested address of an app while accessing an address in a protected memory area. If an instruction for the access-through mode is given, the memory protect controller 106 accesses the original requested address of the app.

The multi-core processor system 100 executes a low-reliability app 111 and a high-reliability app 112. For example, the CPU #1 executes the low-reliability app 111 and the CPU #2 executes the high-reliability app 112. The multi-core processor system 100 establishes a low-reliability app memory area 122 in a user area 121 as an area string context of the low-reliability app 111. Similarly, the multi-core processor system 100 establishes a high-reliability app memory area 123 in the user area 121 as an area storing context of the high-reliability app 112. The context is data used by the apps such as a program counter and a stack pointer, which are values of a register of a CPU.

The multi-core processor system 100 establishes a protect area 124, which is an area different from the user area 121, and establishes a high-reliability app memory area 125. The high-reliability app memory area 125 stores the same data as the high-reliability app memory area 123. With regard to a method of storing the same data, the CPU #2 registers the dual access mode in the memory protect controller 106#2 at the timing of execution of the high-reliability app 112. If a write access occurs, the memory protect controller 106#2 in the dual access mode writes into the high-reliability app memory area 123, contents that are to be written, while writing the same contents into the high-reliability app memory area 125.

In FIG. 1A, it is assumed that unauthorized writing by the low-reliability app 111 corrupts data in the high-reliability app memory area 123 while the high-reliability app memory area 123 is protected in this way. When executing the high-reliability app 112, the CPU #2 reads the high-reliability app memory area 123 for the execution; however, the data of the high-reliability app memory area 123 does not indicate a correct value and the high-reliability app 112 is forcibly terminated. For example, if the program counter of the high-reliability app memory area 123 is rewritten into an invalid address, the CPU #2 uses a value of the invalid address as an execution code for the execution, and the high-reliability app 112 is forcibly terminated.

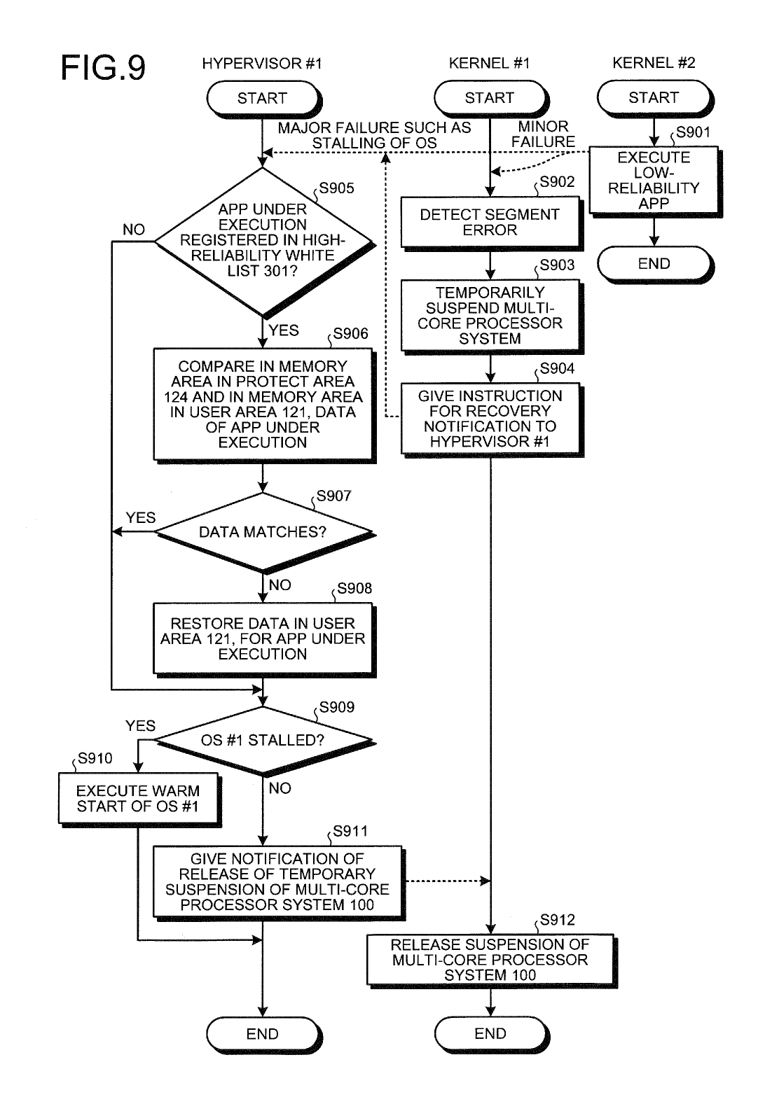

In addition to the forcible termination of the high-reliability app 112 due to unauthorized writing, an OS may stall. Operation in a case of stalling of the OS will be described with reference to FIG. 9.

FIG. 1B depicts a restoration process after data corruption. When detecting that an error occurs with respect to the high-reliability app 112, the CPU #2 determines whether the high-reliability app 112 is under execution. If the high-reliability app 112 is under execution, the CPU #2 compares the high-reliability app memory area 123 and the high-reliability app memory area 125, and if a difference exists, the CPU #2 overwrites the high-reliability app memory area 123 with the high-reliability app memory area 125. As a result, since the data subjected to the unauthorized writing is restored into the proper data, the CPU #2 can continue the high-reliability app 112 and therefore, the high-reliability app 112 can be protected.

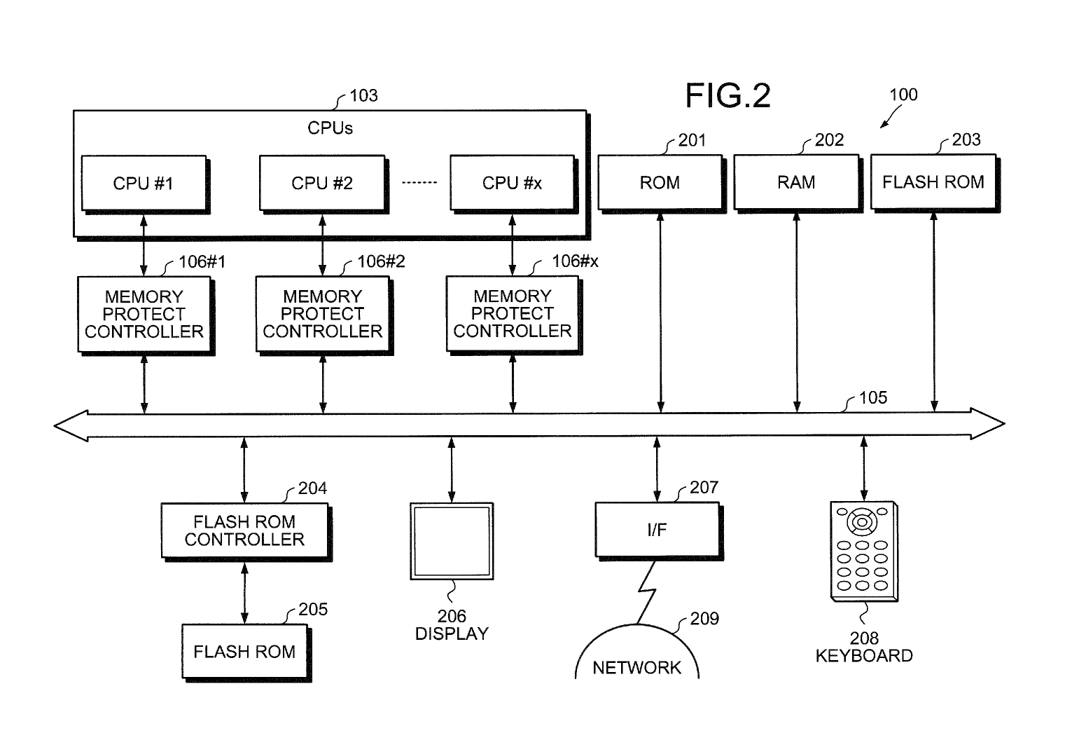

FIG. 2 is a block diagram of a hardware example of the multi-core processor system 100. In FIG. 2, the multi-core processor system 100 includes the CPUs 103 including multiple CPUs, a read only memory (ROM) 201, and a random access memory (RAM) 202. The multi-core processor system 100 includes a flash ROM 203, a flash ROM controller 204, and a flash ROM 205. The memory 104 may be the entire the RAM 202 or a portion thereof. The memory 104 may include the ROM 201, the flash ROM 203, and the flash ROM 205.

The multi-core processor system 100 includes a display 206, an interface (I/F) 207, and a keyboard 208 as input/output apparatuses for a user and other devices. The units are connected through the bus 105.

The CPUs 103 are responsible for overall control of the multi-core processor system 100. The CPUs 103 refer to all the CPUs that are single-core processors connected in parallel. The CPUs 103 include CPUs #1 to #x, where x is an integer greater than or equal to two. A multi-core processor system is a system of a computer including a processor equipped with multiple cores. As long as multiple cores are provided, the multi-core processor system may have a single processor equipped with multiple cores or a group of single-core processors arranged in parallel. This embodiment will be described taking a parallel arrangement of CPUs that are single-core processors as an example.

The CPUs #1 to #x can communicate with the respective memory protect controllers 106. The CPUs #1 to #x may have respective dedicated cache memories.

The ROM 201 stores therein programs such as a boot program. The RAM 202 is used as a work area of the CPUs 103. The flash ROM 203 stores system software such as an operating system (OS), and application software. For example, when the OS is updated, the multi-core processor system 100 receives a new OS via the I/F 207 and updates the old OS that is stored in the flash ROM 203 with the received new OS.

The flash ROM controller 204, under the control of the CPUs 103, controls the reading and writing of data with respect to the flash ROM 205. The flash ROM 205 stores therein data written under control of the flash ROM controller 204. Examples of the data include image data and video data acquired by the user of the multi-core processor system through the I/F 207, and the a program that causes the execution of the software protecting method according to the present embodiment. A memory card, SD card and the like may be adopted as the flash ROM 205.

The display 206 displays, for example, data such as text, images, functional information, etc., in addition to a cursor, icons, and/or tool boxes. A thin-film-transistor (TFT) liquid crystal display and the like may be employed as the display 206.

The I/F 207 is connected to a network 209 such as a local area network (LAN), a wide area network (WAN), and the Internet through a communication line and is connected to other apparatuses through the network 209. The I/F 207 administers an internal interface with the network 209 and controls the input and output of data with respect to external apparatuses. For example, a modem or a LAN adaptor may be employed as the I/F 207.

The keyboard 208 includes, for example, keys for inputting letters, numerals, and various instructions and performs the input of data. Alternatively, a touch-panel-type input pad or numeric keypad, etc. may be adopted.

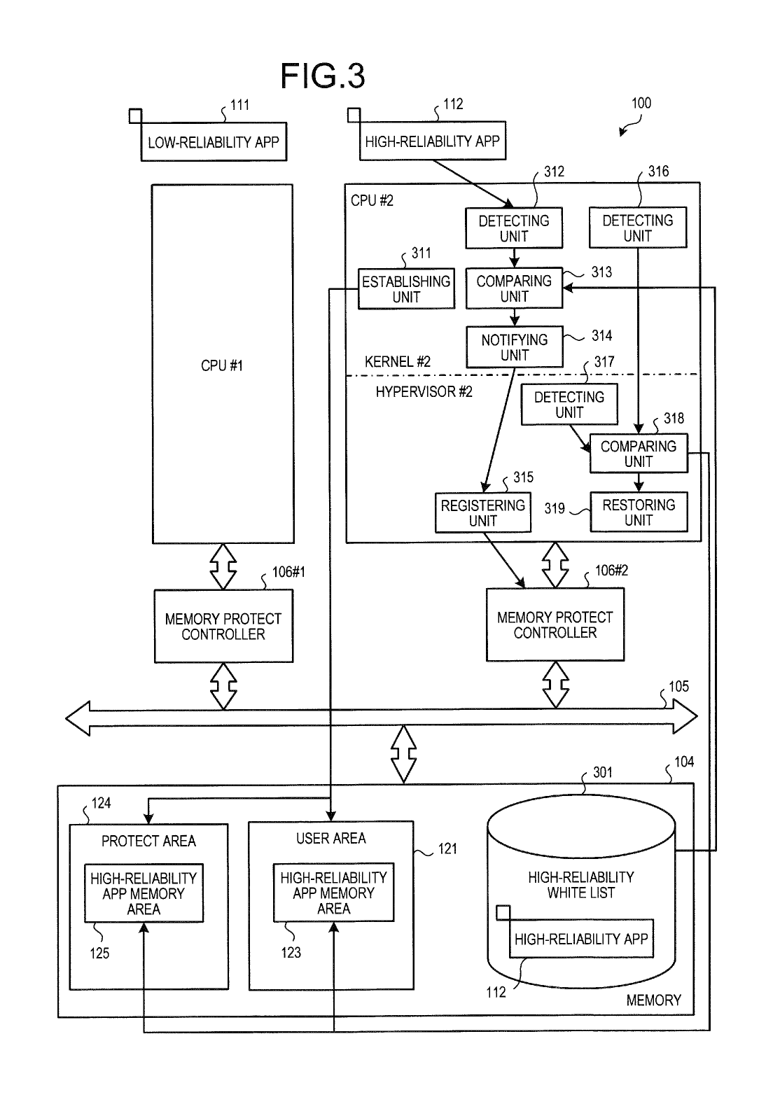

An example of a functional configuration of the multi-core processor system 100 will be described. FIG. 3 is a block diagram of an example of a functional configuration of the multi-core processor system 100. The multi-core processor system 100 can access a high-reliability white list 301 that is a storage area accessed by the functions.

The multi-core processor system 100 includes an establishing unit 311, a detecting unit 312, a comparing unit 313, a notifying unit 314, a registering unit 315, a detecting unit 316, a detecting unit 317, a comparing unit 318, and a restoring unit 319. The functions acting as a control unit (the establishing unit 311 to the restoring unit 319) are implemented by executing on the CPUs #1 to #x, programs stored in a storage device. For example, the storage device includes the ROM 201, the RAM 202, the flash ROM 203, and the flash ROM 205 depicted in FIG. 2. Alternatively, the functions may be implemented by executing the programs via the I/F 207 by another CPU.

Although the establishing unit 311 is a function of the CPU #2 executing the high-reliability app 112 in FIG. 3, the establishing unit 311 may be a function of any of the CPUs #1 and #3 to #x. The detecting unit 312 to the restoring unit 319 may be functions included in all of the CPUs #1 to #x.

The CPU #2 executes a hypervisor #2, an OS #2, and a kernel #2. The hypervisor #2 is a program directly operating on hardware such as the CPU #2. The hypervisor #2 is a program capable of executing privileged instructions for directly referring to the register in the CPU #2, reading information of the register in the CPU #2, and rewriting information in the register in the CPU #2. The kernel #2 is a core function of the OS #2 and, for example, manages the resources of the multi-core processor system 100 to enable software such as a thread to access hardware.

Although not depicted, the OS #2 is a program controlling the CPU #2. For example, the OS #2 provides libraries that access the resources in the multi-core processor system 100, an application programming interface (API), etc., to apps.

Although not depicted, the CPUs #1 and #3 to #x also execute hypervisors, OSs, and kernels. The establishing unit 311 to the notifying unit 314 and the detecting unit 316 are included in the functions of the kernel #2; and the registering unit 315 and the detecting unit 317 to the restoring unit 319 are included in the functions of the hypervisor #2.

The high-reliability white list 301 is a list to which predetermined apps are registered. A predetermined app to be registered is the high-reliability app 112 subjected to operation verification for the multi-core processor system 100. For example, the high-reliability app 112 is an app preinstalled in the multi-core processor system 100. Apps provided from a manufacturer that manufactures the multi-core processor system 100, a communication carrier providing the network 209, etc., may be registered as the high-reliability app 112. For example, when an app is downloaded from the network 209, if the app is associated with identification information indicating that the app is provided from the manufacture or the communication carrier, the multi-core processor system 100 may register the downloaded app into the high-reliability white list 301.

The contents registered in the high-reliability white list 301 may be a name of an app or, if a file system exists, the contents may be a file path in which a program of an app is stored.

The establishing unit 311 has a function of establishing at the time of system boot, a second memory area that corresponds to a first memory area accessed by multiple CPUs when an app is executed and that is also accessed when the first memory area is accessed by the multiple CPUs. The first memory area is a memory area that is an access destination of an app under execution, and is a user area 121 depicted in FIG. 3. The second memory area is the protect area 124 that is an area protecting the data in the user area 121. The second memory area may be established at the timing of system boot or when an app is invoked.

If the number of apps concurrently executed by the multi-core processor system 100 is N and a memory area allocated at the time of execution of an app is M [bytes], the establishing unit 311 may establish N×M [bytes] as a size of the second memory area. For example, in the case of N=5 and M=1 [M bytes], the establishing unit 311 establishes an area of N×M=5×1=5 [M byte] as the user area 121.

With regard to a value of N, the multi-core processor system 100 according to this embodiment is assumed to be a mobile phone, etc., and it is not assumed that a large number of apps are activated at the same time. For example, the maximum value of N is a value such as 8 and 16. N may be the number of CPUs 103. The address of the established area is stored in a storage area such as the register of the CPU #2, the cache memory, and the RAM 202.

The detecting unit 312 has a function of detecting an event among events including invocation of an app, completion of an app, or a switching of an app. For example, the detecting unit 312 detects that the high-reliability app 112 is invoked. The detected event is stored to a storage area such as the register of the CPU #2, the cache memory, and the RAM 202.

The comparing unit 313 has a function of comparing an app to be executed and apps registered in a predetermined app list if the detecting unit 312 detects an event. For example, the comparing unit 313 compares the high-reliability app 112 to be executed and apps registered in the high-reliability white list 301. The comparison result is stored to a storage area such as the register of the CPU #2, the cache memory, and the RAM 202.

The notifying unit 314 has a function of notifying the hypervisor #2 of an instruction instructing the memory protect controller 106#2 to access the first memory area and the second memory area, for the access from the app to be executed when the comparison result from the comparing unit 313 indicates a match. For example, it is assumed that the high-reliability app 112 matches an app registered in the high-reliability white list 301. In this case, the notifying unit 314 notifies the hypervisor #2 of an instruction instructing the memory protect controller 106#2 to access the high-reliability app memory area 123 and the high-reliability app memory area 125, for the access from the high-reliability app 112.

If the comparison result from the comparing unit 313 indicates a mismatch, the notifying unit 314 may notify the hypervisor #2 of an instruction instructing the memory protect controller 106#2 to access the first memory area, for the access from the app to be executed.

When an app is invoked and a comparison result of the invoked app from the comparing unit 313 indicates a match, the notifying unit 314 may give notification of an instruction to add an area for the invoked app to the second memory area. When an app is completed and a comparison result of the completed app from the comparing unit 313 indicates a match, the notifying unit 314 may give notification of an instruction to release in the second memory area, the area for the completed app. The contents of notification may be stored to a storage area such as the register of the CPU #2, the cache memory, and the RAM 202.

The registering unit 315 has a function of registering the instruction given by the notifying unit 314 into the memory protect controller 106#2. For example, in the case of notification of an instruction for the dual access mode that is a first access mode, the registering unit 315 registers the dual access mode into the memory protect controller 106#2. For example, the registering unit 315 performs the registration into a register in the memory protect controller 106#2.

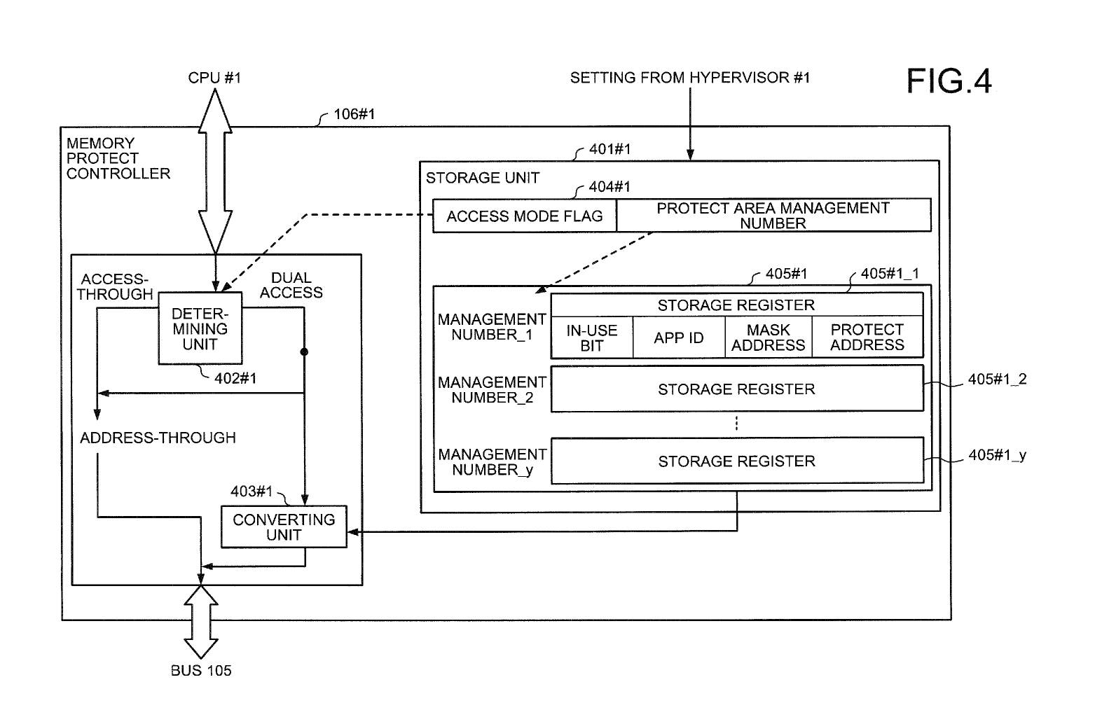

In the case of notification of an instruction for the access-through mode that is a second access mode, the registering unit 315 registers the access-through mode into the memory protect controller 106#2. Specific registration contents will be described with reference to FIG. 4. Information indicating execution of the registration may be stored to a storage area such as the register of the CPU #2, the cache memory, and the RAM 202.

The detecting unit 316 has a function of detecting in the CPU thereof, an app that is forcibly terminated. For example, the detecting unit 316 detects that occurrence of a segment error, etc. indicative of access to an inaccessible memory causes forcible termination of the high-reliability app 112. Information indicative of the forcible termination of the app is stored to a storage area such as the register of the CPU #2, the cache memory, and the RAM 202.

The detecting unit 317 has a function of detecting that the OS #2 has stalled. For example, the detecting unit 317 periodically monitors the OS #2 and detects that the OS #2 has stalled if the OS #2 does not respond. A stalled OS enters an abnormal state in which no response can be made to a request. The stalled state of the OS is also referred to as a kernel panic. The information indicative of stalling of the OS #2 is stored in the storage area such as the register of the CPU #2, the cache memory, and the RAM 202.

The comparing unit 318 has a function of comparing the first memory area and the second memory area if the detecting unit 316 detects forcible termination of an app or if the detecting unit 317 detects the stalling of the OS #2. For example, the comparing unit 318 compares data between the high-reliability app memory area 123 and the high-reliability app memory area 125. The comparing unit 318 may compare the first memory area and the second memory area if the app under execution is registered in the high-reliability white list 301. The comparison result is stored to a storage area such as the register of the CPU #2, the cache memory, and the RAM 202.

The restoring unit 319 has a function of restoring the first memory area based on the comparison result from the comparing unit 318. For example, if the comparison result from the comparing unit 318 indicates a mismatch, the restoring unit 319 overwrites the first memory area with a difference of the comparison result, thereby restoring the first memory area. A result of performing the restoration may be stored in the storage area such as the register of the CPU #2, the cache memory, and the RAM 202.

FIG. 4 is an explanatory view of an example of an internal functional configuration of the memory protect controller 106. Although the functions will be described by taking the memory protect controller 106#1 as an example, the memory protect controllers 106#2 to 106#x have the same functions as the memory protect controller 106#1. The memory protect controller 106#1 includes a storage unit 401#1, a determining unit 402#1, and a converting unit 403#1.

The storage unit 401#1 stores an access mode of the memory protect controller 106 and a protect area corresponding to an app. For example, the storage unit 401#1 includes a control register 404#1 and storage registers 405#1_1 to 405#1_y, where y is an integer greater than or equal to one.

A specific value of y may be a maximum value of the number of apps concurrently executable by the CPU #1. The multi-core processor system 100 according to this embodiment is assumed to be a mobile phone etc., and it is not assumed that a large number of apps are activated at the same time as in the case of a personal computer. Therefore, the maximum number of apps concurrently executed by each CPU is a value not based on the assumption that a large number of apps are activated at the same time. Additionally, y is a value less than or equal to N. For example, y is a value such as 4 or 8.

The control register 404#1 includes two fields for an access mode flag and a protect area management number. The access mode flag field stores an identifier representing access mode information of either the dual access mode for accessing two addresses or the access-through mode for normal access. For example, a specific identifier may be “1”, which means the dual access mode. The protect area management number field stores a value indicating which storage register 405#1 is applied among the storage registers 405#1_1 to 405#1_y if two addresses are accessed. For example, if the protect area management number field stores “1”, the converting unit 403#1 uses the setting of the storage register 405#1_1 for conversion.

The storage registers 405#1_1 to 405#1_y are registers storing a protect area for each app. The storage registers 405#1_1 to 405#1_y respectively correspond to management numbers _1 to y. Fields in the storage register 405#1 will be described. The storage register 405#1 includes four fields for an in-use bit, app ID, mask address, and protect address.

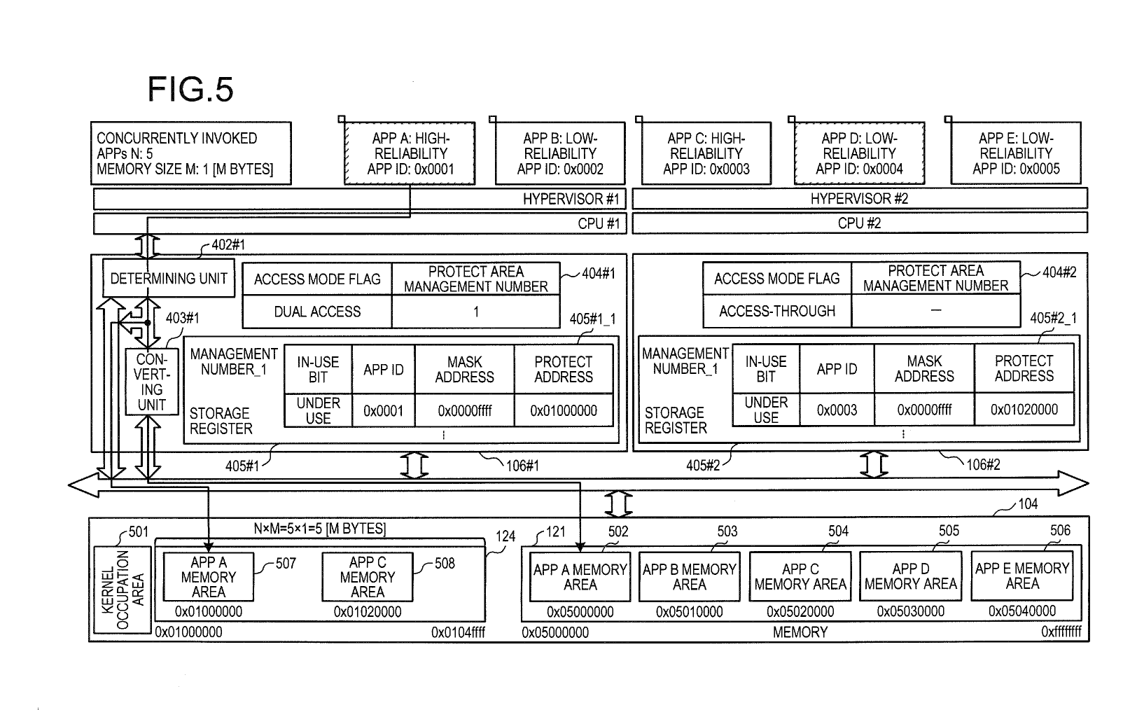

The in-use bit field stores a bit indicating whether the corresponding storage register 405#1 is being used. The app ID field stores identification information of the app under execution at the CPU #1. The mask address field stores an address indicating a memory range accessed by the app. A specific size of the memory range is determined by a memory management mechanism included in the OS. The protect address field stores an address to a protect area of the app under execution at the CPU #1. Specific setting examples of the control register 404#1 and the storage register 405#1 will be described later with reference to FIG. 5.

The determining unit 402#1 has a function of determining whether address conversion is performed depending on the access mode information stored in the storage unit 401#1. For example, the determining unit 402#1 accesses to two addresses if the access mode flag field indicates the dual access mode, or passes an address therethrough without address conversion if the access mode flag field indicates the access-through mode.

The converting unit 403#1 has a function of performing address conversion for one access destination if the determining unit 402#1 determines that the access mode is the dual access mode. For example, the converting unit 403#1 performs the address conversion by reference to the mask address field and the protect address field of the storage register 405#1 corresponding to the management number set in the protect area management number field. For example, the converting unit 403 performs the conversion according to Equation (1):

converted address=address before conversion & mask address+protect address (1)

For example, it is assumed that an access destination from an app corresponding to the address before conversion is 0x05000100, that the mask address field is 0x0000ffff, and that the protect address field is 0x01000000. In this case, the converting unit 403 performs the conversion according to Equation (1) as follows:

converted address=0x05000100&0x0000ffff+0x01000000 [symbol] address after conversion=0x01000100

Between read request access and write request access from the CPU #1, the memory protect controller 106#1 may implement the dual access mode for the write request access. This is because even if the dual access mode is implemented for the read request access while no error occurs, the same value is returned and therefore, the read access to an unconverted address is sufficient.

FIG. 5 is an explanatory view of a registration example of the memory protect controller 106. The multi-core processor system 100 depicted in FIG. 5 executes apps A and C that are high-reliability apps registered in the high-reliability white list 301, and apps B, D, and E that are low-reliability apps not registered in the high-reliability white list 301. The apps A and B are allocated to the CPU #1 and the apps C to E are allocated to the CPU #2. The CPU #1 executes the app A and the CPU #2 executes the app D. The app IDs of the apps A to E are 0x0001, 0x0002, 0x0003, 0x0004, and 0x0005, respectively.

When the OS is booted, a kernel #1 establishes a memory area of 0x00000000 to 0x00500000 as a kernel occupation area 501. The kernel #1 then establishes a protect area 124 before establishing the user area 121 that is an operation space of the apps. For example, it is assumed that the number of concurrently executed apps of the multi-core processor system 100 is N=5 and that the memory size M allowed for one app is 1 [M byte].

In this case, the kernel #1 establishes 0x01000000 to 0x0104ffff of N×M=5×1=5 [M bytes] as the protect area 124. The kernel #1 then establishes 0x05000000 to 0xffffffff as the user area 121. The kernel #1 stores 0x05000000−0x01000000=0x04000000 as an offset address from the user area 121 to the protect area 124. Because of M=1 [M bytes], the mask address corresponding to an address range accessed by one app is 0x0000ffff. In this embodiment, the address range accessed by one app is assumed to be always fixed for simplicity of description.

In this case, the protect area 124 is an area not accessible by the apps. Therefore, for example, if the apps A and B attempt to access the protect area 124 through the OS #1, the kernel #1 issues a segment error indicating access of an area outside the management of the OS #1. As described above, the multi-core processor system 100 can set the protect area 124 as an area other than the user area 121 to prevent the unauthorized writing into the protect area 124 by the low-reliability apps.

The area serving as the protect area 124 may be a discontinuous range and need not be fixed, i.e., the area may be established in a dispersed manner and may be changed dynamically during execution of the multi-core processor system 100, as long as the memory protect controller 106 can manage the area. In this embodiment, for simplicity of description, the area serving as the protect area 124 is described as a continuous range and being fixed.

When the apps A to E are invoked, the multi-core processor system 100 establishes areas to store contexts of the apps in the user area 121. For example, the kernel #1 establishes an app A memory area 502 when the app A is invoked and establishes an app B memory area 503 when the app B is invoked. The kernel #2 establishes an app C memory area 504 when the app C is invoked, establishes an app D memory area 505 when the app D is invoked, and establishes an app E memory area 506 when the app E is invoked. The initial addresses of the app A memory area 502 to the app E memory area 506 are 0x05000000, 0x05010000, 0x05020000, 0x05030000, and 0x05040000, respectively.

If a high-reliability app is activated, the multi-core processor system 100 establishes a memory area in the protect area 124. For example, a hypervisor #1 receiving an instruction from the kernel #1 establishes an app A memory area 507 when the app A is invoked.

In a method of setting the address of the app A memory area 507, for example, the hypervisor #1 sets as the initial address of the app A memory area 507, an address acquired by subtracting the offset address to the user area 121 from the initial address of the app A memory area 502. For example, the hypervisor #1 sets the initial address 0x05000000 of the app A memory area 502−the offset address 0x04000000=0x01000000 as the initial address of the app A memory area 507.

The hypervisor #1 then sets a value in the storage register 405#1_1. For example, the hypervisor #1 sets “under use” in the in-use bit field and sets the app ID 0x0001 of the app A in the app ID field. The hypervisor #1 then sets 0x0000ffff in the mask address field and sets the initial address 0x01000000 of the app A memory area 507 in the protect address field.

Similarly, the hypervisor #2 establishes an app C memory area 508 when the app C is invoked. The hypervisor #2 sets a value in the storage register 405#2_1. For example, the hypervisor #2 sets “under use” in the in-use bit field and sets the app ID 0x0003 of the app C in the app ID field. The hypervisor #2 then sets 0x0000ffff in the mask address field and sets the initial address 0x01020000 of the app C memory area 508 in the protect address field.

At the stage described above, the multi-core processor system 100 completes the stage of app invocation and shifts to actual operating state. The CPU #1 executes the apps in the order of the app A, the app B, the app A, etc. When an app switching event occurs and the CPU #1 executes the app A, since the app A is registered in the high-reliability white list 301, the kernel #1 instructs the hypervisor #1 to set the access mode to the dual access mode. In this case, the kernel #1 includes a switched app ID in instruction contents.

The instructed hypervisor #1 registers the dual access mode into the memory protect controller 106#1. For example, the hypervisor #1 sets the access mode flag of the memory protect controller 106#1 to the dual access mode. The hypervisor #1 sets the management number of the storage register 405#1 matching the app ID of the instruction in the protect area management number field. With such operation, the multi-core processor system 100 operates in the dual access mode, the access-through mode, etc., in the memory protect controller 106#1 in synchronization with the operation switched to the app A, the app B, etc., in the OS #1.

In this operation, when the app A is under execution, the multi-core processor system 100 accesses two address spaces of 0x05000000 and 0x01000000. Although the double access may deteriorate performance of bus access, bandwidth of CPU access is generally in a sparse state in which the bandwidth of the bus is not entirely used, such as setting a 128 [bit] bandwidth bus for a CPU of a 64 [bit] system. Therefore, the deterioration in bus access performance can be avoided by an interlocking with a data packing function of integrating two 64 [bit] accesses into one 128 [bit] access in the bus 105.

Similarly, the CPU #2 executes the apps in the order of the app C, the app D, the app E, the app C, etc. When the CPU #2 executes the app D, since the app D is not registered in the high-reliability white list 301, the kernel #2 instructs the hypervisor #2 to set the access mode to the access-through mode consequent to the occurrence of an app switching event. In this case, the kernel #2 includes a switched app ID in the instruction contents. The instructed hypervisor #2 registers the access-through mode into the memory protect controller 106#2. For example, the hypervisor #2 sets the access mode flag of the memory protect controller 106#2 to the access-through mode.

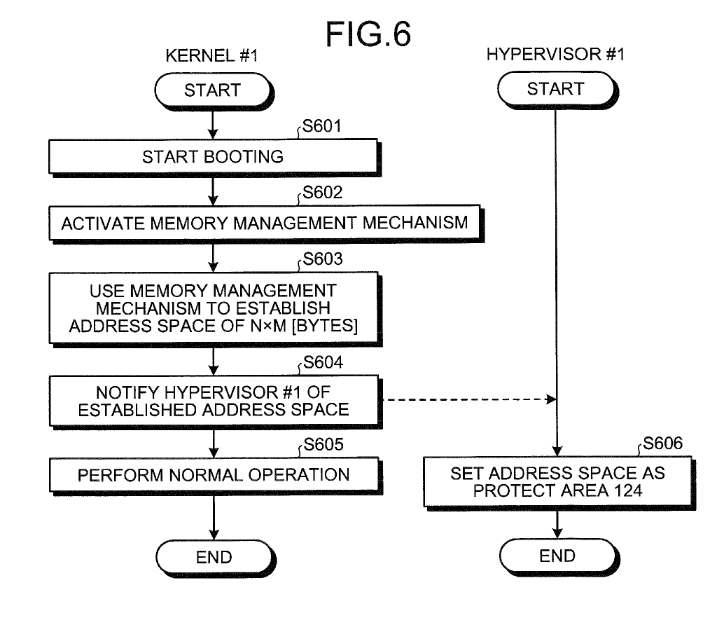

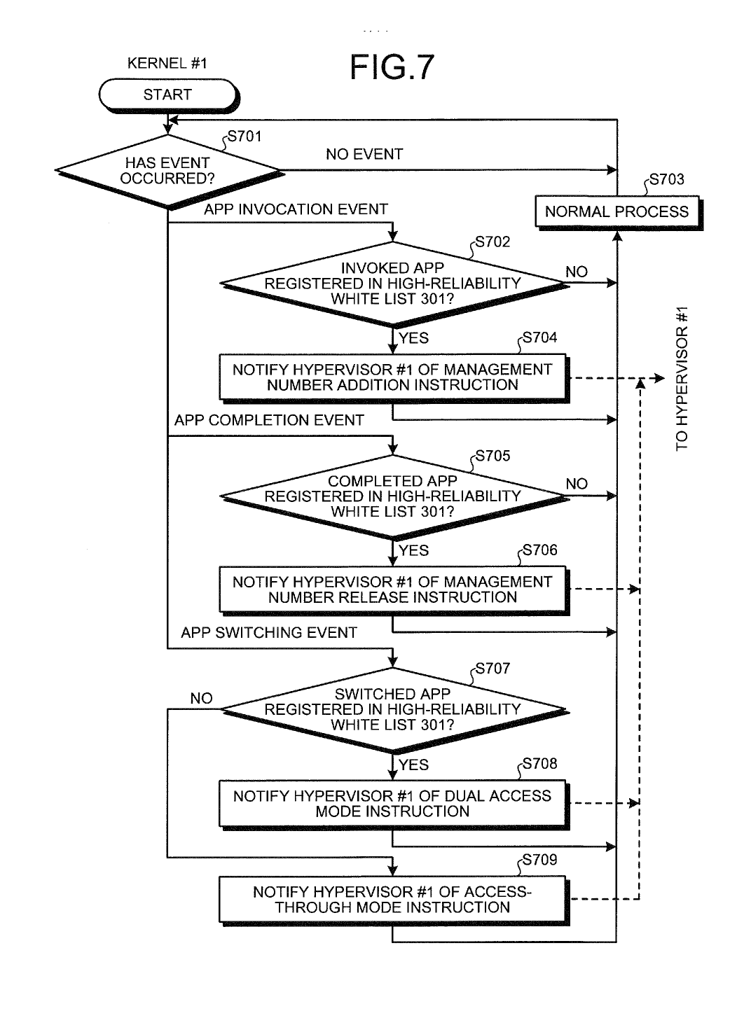

Flowcharts of the operation described with reference to FIG. 5 will be described with reference to FIGS. 6 to 9. Although an execution entity executing an example of a process procedure at the time of activation depicted in FIG. 6 may be any of the CPUs #1 to #x, the flowchart will be described on the assumption that the CPU #1 executes the procedure for simplicity of description. Although an execution entity executing a process procedure at the time of app switching and a process procedure at the time of an error depicted in FIGS. 7 to 9 is executed at all of the CPUs #1 to #x, the flowcharts will be described on the assumption that the CPU #1 executes the procedures for simplicity of description.

FIG. 6 is a flowchart of an example of a process procedure at the time of activation of the multi-core processor system 100. When booting starts (step S601), the kernel #1 activates the memory management mechanism (step S602). The kernel #1 uses the memory management mechanism to establish an address space of N×M [bytes] (step S603).

After the establishment, the kernel #1 notifies the hypervisor #1 of the established address space (step S604), performs normal operation (step S605), and ends the process. Normal operation includes establishing the user area 121 and activating the app activated at the beginning of booting. The hypervisor #1 notified of the address space sets the address space of the notification as the protect area 124 (step S606) and ends the process. As a result, the multi-core processor system 100 can establish the memory protest area for the high-reliability apps.

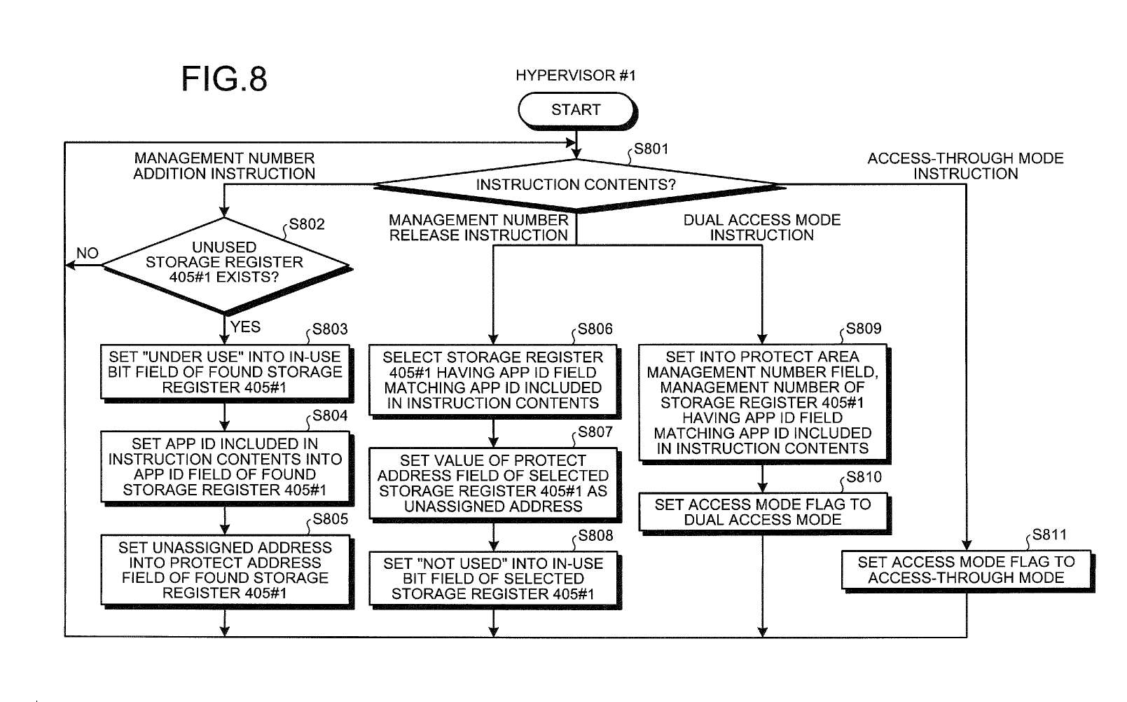

FIGS. 7 and 8 depict an example of a process procedure at the time of app switching in the multi-core processor system 100. FIG. 7 depicts an example of the process procedure of the kernel #1 and FIG. 8 depicts an example of the process procedure of the hypervisor #1.

FIG. 7 is a flowchart (part 1) of an example of the process procedure at the time of app switching in the multi-core processor system 100. The kernel #1 determines whether an event has occurred (step S701). If no event has occurred (step S701: NO EVENT), the kernel #1 re-executes step S701 after a certain time. The kernel #1 may execute another process of the kernel #1 after a certain time.

If an app invocation event has occurred (step S701: APP INVOCATION EVENT), the kernel #1 determines whether the invoked app is registered in the high-reliability white list 301 (step S702). If registered (step S702: YES), the kernel #1 notifies the hypervisor #1 of a management number addition instruction (step S704). In the operation at step S704, the kernel #1 includes the app ID of the invoked app in the instruction contents.

After the notification, the kernel #1 executes a normal process (step S703) and goes to the operation at step S701. If not registered (step S702: NO), the kernel #1 goes to the operation at step S703. A normal process at time of the app invocation event is, for example, a process of establishing an area to store the context of the invoked app in the user area 121.

If an app completion event has occurred (step S701: APP COMPLETION EVENT), the kernel #1 determines whether the completed app is registered in the high-reliability white list 301 (step S705). If registered (step S705: YES), the kernel #1 notifies the hypervisor #1 of a management number release instruction (step S706). In the operation at step S706, the kernel #1 includes the app ID of the completed app in the instruction contents.

After the notification, or if not registered (step S705: NO), the kernel #1 goes to the operation at step S703. A normal process of the app completion event is, for example, a process of releasing in the user area 121, the area storing the context of the completed app established.

If an app switching event has occurred (step S701: APP SWITCHING EVENT), the kernel #1 determines whether the switched app is registered in the high-reliability white list 301 (step S707). If registered (step S707: YES), the kernel #1 notifies the hypervisor #1 of a dual access mode instruction (step S708). In the operation at step S708, the kernel #1 includes the app ID of the switched app in the instruction contents. After the notification, the kernel #1 goes to the operation at step S703. If not registered (step S707: NO), the kernel #1 notifies the hypervisor #1 of an access-through mode instruction (step S709). After the notification, the kernel #1 goes to the operation at step S703.

A normal process of the app switching event is, for example, a dispatch process. The dispatch process is to save the register, etc. of the CPU into the area storing the context of the app before switching and to set into the register of the CPU, a value of the register saved in the area storing the context of the switched app.

As a result, the multi-core processor system 100 can give instructions for a setting change to the memory protect controller 106 for events such as invocation, termination, and switching of the apps.

FIG. 8 is a flowchart (part 2) of an example of the process procedure at the time of app switching in the multi-core processor system 100. In FIG. 8, it is assumed that the hypervisor #1 sets the control register 404#1 and the storage registers 405#1 in the memory protect controller 106. Therefore, the descriptions of steps will not include the description that a register to be set is a register in the memory protect controller 106 for simplicity of description.

The hypervisor #1 checks the instruction contents (step S801). If the instruction contents represent the management number addition instruction (step S801: MANAGEMENT NUMBER ADDITION INSTRUCTION), the hypervisor #1 determines whether an unused storage register 405#1 exists among the storage registers 405#1_1 to 405#1_y (step S802).

If an unused storage register 405#1 exists (step S802: YES), the hypervisor #1 sets “under use” into the in-use bit field of the found storage register 405#1 (step S803). The hypervisor #1 then sets the app ID included in the instruction contents into the app ID field of the found storage register 405#1 (step S804). The hypervisor #1 sets an unassigned address into the protect address field of the found storage register 405#1 (step S805) and goes to the operation at step S801. If no unused storage register 405#1 exists (step S802: NO), the hypervisor #1 goes to the operation at step S801.

The unassigned address at step S805 is an address of a memory area not allocated as a memory area of the other high-reliability apps. Although the operations at steps S803 to S805 include no description about the mask address field, it is assumed that the mask address of this embodiment is always a fixed value. Therefore, for example, the mask address field is set at step S606 described above, where the hypervisor #1 sets 0x0000ffff in the mask address fields of the storage registers 405#1_1 to 405#1 y.

If the instruction contents represent a management number release instruction (step S801: MANAGEMENT NUMBER RELEASE INSTRUCTION), the hypervisor #1 selects the storage register 405#1 having an app ID field matching the app ID included in the instruction contents among the storage registers 405#1_1 to 405#1_y (step S806). After the selection, the hypervisor #1 sets the value of the protect address field of the selected storage register 405#1 as an unassigned address (step S807). The hypervisor #1 sets “not used” into the in-use bit field of the selected storage register 405#1 (step S808) and goes to the operation at step S801.

If the instruction contents represent the dual access mode instruction (step S801: DUAL ACCESS MODE INSTRUCTION), the hypervisor #1 sets into the protect area management number field, the management number of the storage register 405#1 having the app ID field matching the app ID included in the instruction contents (step 809). The hypervisor #1 then sets the access mode flag to the dual access mode (step S810) and goes to the operation at step S801.

If the instruction contents represent the access-through mode instruction (step S801: ACCESS-THROUGH MODE INSTRUCTION), the hypervisor #1 sets the access mode flag to the access-through mode (step S811) and goes to the operation at step S801. As described above, the multi-core processor system 100 changes settings for the memory protect controller 106 according to event, such as invocation, completion, and switching of the apps and therefore can change the access mode concurrently with the events of the apps.

An example of the process procedure at the time of an error will be described with reference to FIG. 9. In a flowchart of FIG. 9, it is assumed that insufficient operation verification of a low-reliability app executed by the CPU #2 leads to an occurrence of failure as a result of writing into another memory area by the low-reliability app. Two types of states are caused by the trouble.

In a first state, a high-reliability app is terminated by a simple program error. For example, if an error occurs with the high-reliability app executed by the OS #1, the OS #1 detects the occurrence of the error and can notify the supervisor #1. In a second state, the OS #1 stalls. If the OS #1 stalls, the failure state of the high-reliability app cannot be detected. Therefore, the hypervisor #1 operating independently of the OS #1 detects whether the OS #1 has stalled, via periodic monitoring.

FIG. 9 is a flowchart of an example of a process procedure at the time of an error of the multi-core processor system 100. The kernel #2 executes a low-reliability app (step S901). It is assumed that as a result of this execution, unauthorized writing to the user area 121 occurs and causes failure.

If a minor failure such as forcible termination of an app is caused due to the unauthorized writing, the kernel #1 detects a segment error (step S902). After the detection, the kernel #1 suspends the multi-core processor system 100 (step S903) and gives an instruction for recovery notification to the hypervisor #1 (step S904).

If a major failure such as stalling of OS occurs and is detected by the periodic monitoring, or if an instruction for recovery notification is given, the hypervisor #1 determines whether the app under execution is registered in the high-reliability white list 301 (step S905). If registered (step S905: YES), the hypervisor #1 compares in the memory area in the protect area 124 and in the memory area in the user area 121, data of the app under execution (step S906).

The hypervisor #1 then determines whether data matches (step S907). If the data does not match (step S907: NO), the hypervisor #1 restores the data in the user area 121, for the app under execution (step S908). For example, for the app under execution, the hypervisor #1 overwrites the memory area in the user area 121 with a difference of the comparison result. As a result, data subjected to unauthorized writing is restored to proper data.

If the app is not registered in the high-reliability white list 301 (step S905: NO), if the compared data matches (step S907: YES), or after data restoration, the hypervisor #1 determines whether the OS #1 is stalled (step S909). If stalled (step S909: YES), the hypervisor #1 executes a warm start of the OS #1 (step S910) and terminates the process at the time of an error. A specific method of the warm start may be implemented by applying a check point restart technique or a hibernation technique.

If the OS #1 is not stalled (step S909: NO), the hypervisor #1 notifies the kernel #1 of release of suspension of the multi-core processor system 100 (step S911) and ends the process. The kernel #1 accepting the release of suspension cancels the suspension of the multi-core processor system 100 (step S912) and ends the process. As described above, if an error is caused in a high-reliability app by memory corruption due to unauthorized writing, the multi-core processor system 100 can restore data and continue operation.

As described above, the multi-core processor system establishes the second memory area, which is different from the first memory area accessed by a high-reliability app, and writes the same contents. As a result, even if a low-reliability app corrupts the first memory area and failure occurs, the multi-core processor system is able to use the second memory area for recovery and therefore, is able to execute the high-reliability app and the low-reliability app in a mixed manner.

The software protecting method implemented by the multi-core processor system according to this embodiment enables software assets of a single core processor system to be securely inherited in a multi-core processor system environment. The multi-core processor system according to this embodiment can be operated in a normal operation state without generating biased disadvantageous scheduling such as preventing execution of the low-reliability app during execution of the high-reliability app, for example. Since a recovery process is implemented when a failure occurs and no heavy-load process is executed in a normal operation state, the multi-core processor system according to this embodiment does not deteriorate overall performance.

The multi-core processor system is able to access a list storing predetermined apps and compare an app to be executed with the apps stored in the list. As a result, the multi-core processor system is able to determine whether the app to be executed is a high-reliability app.

If the app to be executed matches an app stored in the list, the multi-core processor system may perform registration in the memory protect controller corresponding to the CPU executing the app such that the first memory and the second memory area are accessed. As a result, the multi-core processor system is able to protect the data of the high-reliability app.

If the app to be executed does not match any app stored in the list, the multi-core processor system may perform registration in the memory protect controller corresponding to the CPU executing the app such that the first memory is accessed. As a result, the multi-core processor system is able to refrain from protecting data for a low-reliability app, which has no need for data protection, and the multi-core processor system is able to effectively use the protect area established for data protection.

The multi-core processor system may restore the first memory area based on a comparison result between the first memory area and the second memory area in response to detection of abnormality in the multi-core processor system. As a result, the multi-core processor system is able recover an app having a failure.

The multi-core processor system may protect an app subjected to operation verification in the multi-core processor system environment as a high-reliability app. A low-reliability app may corrupt the first memory area by itself and in this case, even if the data is protected in the second memory area by the memory protect controller, the second memory is corrupted as well. Even if the data of the first memory area is restored in this state, the data is overwritten by corrupted data and the multi-core processor system is unable to recover the data. Therefore, the multi-core processor system is able target the high-reliability app verified as having no trouble so as to enable recovery from a failure of the high-reliability app consequent to operation of the low-reliability app.

Although the software protecting method implemented by the multi-core processor system described in this embodiment has been described based on a case where an app is the object, this embodiment is applicable when the object is a library.

The software protection method executed by the multi-core processor system and described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

The memory protect controller 106 described in the present embodiment can be realized by an application specific integrated circuit (ASIC) such as a standard cell or a structured ASIC, or a programmable logic device (PLD) such as a field-programmable gate array (FPGA). Specifically, for example, functional units (storage unit 401 to converting unit 403) of the memory protect controller 106 are defined in hardware description language (HDL), which is logically synthesized and applied to the ASIC, the PLD, etc., thereby enabling manufacture of the memory protect controller 106.

According to one aspect of the embodiment, operation of a high-reliability app and a low-reliability app in a mixed manner is enabled.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A multi-core processor system comprising:
a plurality of CPUs;
a memory; and
a memory protect controller that is disposed between the plurality of CPUs and the memory, wherein
the memory protect controller accesses a first memory area consequent to an access request of the CPUs upon application execution and further accesses a second memory area established when the system is booted.

2. The multi-core processor system according to claim 1, comprising
a table that stores a list of predetermined applications, wherein
a CPU that is among the CPUs is configured to compare an application to be executed and the applications on the list.

3. The multi-core processor system according to claim 2, wherein
the CPU is further configured to register, when a comparison result indicates a match, an instruction for the application to access the first memory area and the second memory area.

4. The multi-core processor system according to claim 2, wherein
the CPU is further configured to register, when a comparison result indicates no match, an instruction for the application to access the first memory area.

5. The multi-core processor system according to claim 1, wherein
a CPU that is among the CPUs is configured to restore the first memory area, in response to detection of abnormality of the multi-core processor system and based on a result of comparison of the first memory area and the second memory area when an application that is to be executed is under execution.

6. The multi-core processor system according to claim 1, wherein
the predetermined applications are applications subjected to operation verification in a multi-core processor system environment.

7. The multi-core processor system according to claim 1, wherein
the second memory is of a size N×M, where a count of the CPUs is N, which is an integer at least equal to two, and a memory area of the memory allocated upon application execution is M, which is an integer at least equal to one, bytes.

8. A multi-core processor system comprising:
a plurality of CPUs;
a memory; and
a memory protect controller that is disposed between the plurality of CPUs and the memory, wherein
the memory protect controller accesses a first memory area when an application is executed and access mode information indicates a second access mode, and
the memory protect controller further accesses a second memory area when the access mode information indicates a first access mode, the memory protect controller accessing the second memory area when the application is executed and in a same way as when accessing the first memory area.

9. The multi-core processor system according to claim 8, wherein
the access mode information is set based on a result of comparison of the application and applications registered in a list.

10. The multi-core processor system according to claim 9, wherein
the access mode information is set to the first access mode, when the result of comparison indicates a match, and
the access mode information is set to the second access mode, when the result of comparison indicates no match.
